(19) United States
(12) Patent Application Publication
(10) Pub. No.: US 2007/0247643 A1
(43) Pub. Date: Oct. 25, 2007

(54) DISPLAY CONTROL APPARATUS, IMAGE PROCESSING APPARATUS, AND DISPLAY CONTROL METHOD

(75) Inventors: Mahina Nakamura, Musashino-shi (JP); Maki Sato, Yokohama-shi (JP); Tsunehiro Motegi, Shinjuku-ku (JP); Yumiko Okuma, Nakano-ku (JP); Yasutsugu Sasaki, Kawasaki-shi (JP)

Correspondence Address: AMIN, TUROCY & CALVIN, LLP, 1900 EAST 9TH STREET, NATIONAL CITY CENTER, 24TH FLOOR,, CLEVELAND, OH, 44114, US

(73) Assignees: KABUSHIKI KAISHA TOSHIBA, Tokyo (JP); TOSHIBA TEC KABUSHIKI KAISHA, Tokyo (JP)

(21) Appl. No.: 11/736,701

(22) Filed: Apr. 18, 2007

(30) Foreign Application Priority Data
Apr. 20, 2006 (JP) 2006-116716

(51) Int. Cl. G06F 3/12

(52) U.S. Cl. 358/1.1

(57) ABSTRACT

There is provided a technique capable of appropriately arranging a plurality of objects to be displayed such as icons on a screen so as to contribute to an improvement of convenience for each user.

A display controller for controlling display of a plurality of objects to be displayed, comprises: an importance information acquisition section 203 that acquires information concerning the importance levels in the screen display which are associated with respective objects to be displayed; and a control section 206 that displays objects to be displayed, based on the information acquired by the importance information acquisition section 203, in the display area constituted by the first to n-th (n is an integer number more than 1) substantially ring-like areas, in which an (x−1)th (x is an integer from 2 to n) area is located inside an x-th area, such that objects to be displayed having higher importance than those to be displayed in the x-th area are displayed in the (x−1)th area.

### BACKGROUND OF THE INVENTION

1. Field of the Invention

The present invention relates to an interface screen that displays objects to be displayed such as a character, an icon, and the like thereon and, more particularly, to a display control technique of objects to be displayed on an interface screen.

2. Description of the Related Art

There is known a technique in which, in an apparatus having an interface screen that displays objects to be displayed such as characters or icons, a plurality of icons corresponding to a plurality of setting items are laid out on the interface screen in a vertical or horizontal direction with respect to the screen.

There is also known a technique of customizing the arrangement of a plurality of icons when the icons are displayed on the interface screen (refer to e.g., Jpn. Pat. Appln. Laid-Open Publications Nos. 2005-102001, 11-110182, and 6-175813).

However, the customization function of the interface screen is provided for each apparatus, that is, respective users cannot achieve layout customization in an individual manner on each apparatus. As a result, the respective users do with a provided default screen.

Along with an increase in performance of the interface screen of recent years, the setting content for the interface screen becomes complicated. Thus, when respective users make a setting operation for the interface screen individually in this situation, it takes a tremendous amount of effort and time, thereby deteriorating convenience. Further, it is not always true that the arrangement of icons or the like on a conventional interface screen allows a user to easily find icons indicating important items. Thus, it may take time and effort for the individual user to find target objects such as icons.

### SUMMARY OF THE INVENTION

An embodiment of the present invention has been made to solve the above problems, and an object thereof is to provide a technique capable of appropriately arranging a plurality of objects to be displayed such as icons on a screen so as to contribute to an improvement of convenience for each user.

To solve the above problems, according to a first aspect of the present invention, there is provided a display controller for controlling display of a plurality of objects to be displayed, comprising: an importance information acquisition section that acquires information concerning the importance levels in the screen display which are associated with respective objects to be displayed; and a control section that displays objects to be displayed, based on the information acquired by the importance information acquisition section, in the display area constituted by the first to n-th (n is an integer number more than 1) substantially ring-like areas, in which an (x−1)th (x is an integer from 2 to n) area is located inside an x-th area, such that objects to be displayed having higher importance than those to be displayed in the x-th area are displayed in the (x−1)th area.

According to a second aspect of the present invention, there is provided an image processing apparatus comprising: the display controller having the above configuration; an operation input section that receives a user's input operation made based on the content displayed by the display controller; and an image processing section that performs predetermined image processing based on the input received by the operation input section.

According to a third aspect of the present invention, there is provided an interface screen which is an interface screen for receiving a user's input operation through input sections displayed on the screen, comprising: a ring-like area section constituted by the first to n-th (n is an integer number more than 1) substantially ring-like areas, in which an (x−1)th (x is an integer from 2 to n) area is located inside an x-th area; and a plurality of input sections that receive a user's input operation, the input sections being arranged such that those having a higher selection frequency than those to be positioned in the x-th area are positioned in the (x−1)th area.

According to a fourth aspect of the present invention, there is provided a display control method for controlling display of a plurality of objects to be displayed, comprising: acquiring information concerning the importance levels in the screen display which are associated with respective objects to be displayed; and displaying objects to be displayed, based on the information acquired by the importance information acquisition step, in the display area constituted by the first to n-th (n is an integer number more than 1) substantially ring-like areas, in which an (x−1)th (x is an integer from 2 to n) area is located inside an x-th area, such that objects to be displayed having higher importance than those to be displayed in the x-th area are displayed in the (x−1)th area.

### BRIEF DESCRIPTION OF THE DRAWINGS

FIG. 1 is a perspective view for explaining the outline of an image processing apparatus 1 including a display controller 2 and an interface screen 101 according to an embodiment of the present invention;

FIG. 2 is a block diagram for explaining the display controller 2 according to the present embodiment;

FIG. 3 is a table showing information indicating the selection frequencies of respective objects to be displayed acquired by an importance information acquisition section 203 and importance levels determined by an importance determination section 205 based on the information indicating the selection frequencies;

FIG. 4 is a screen display example which is displayed on the interface screen 101 under control of a control section 206;

FIG. 5 is a table for explaining an example in which groups of object to be displayed are changed in accordance with the selection frequency;

FIG. 6 is a view showing an example in which the interface screen is displayed based on the grouping changed as explained using FIG. 5;

FIG. 7 is a view showing an example of the interface screen obtained by combining a plurality of ring-like areas having different outlines; and

FIG. 8 is a flowchart for explaining a procedure of processing (display control method) performed in the display controller according to the present embodiment.

### DESCRIPTION OF THE EMBODIMENTS

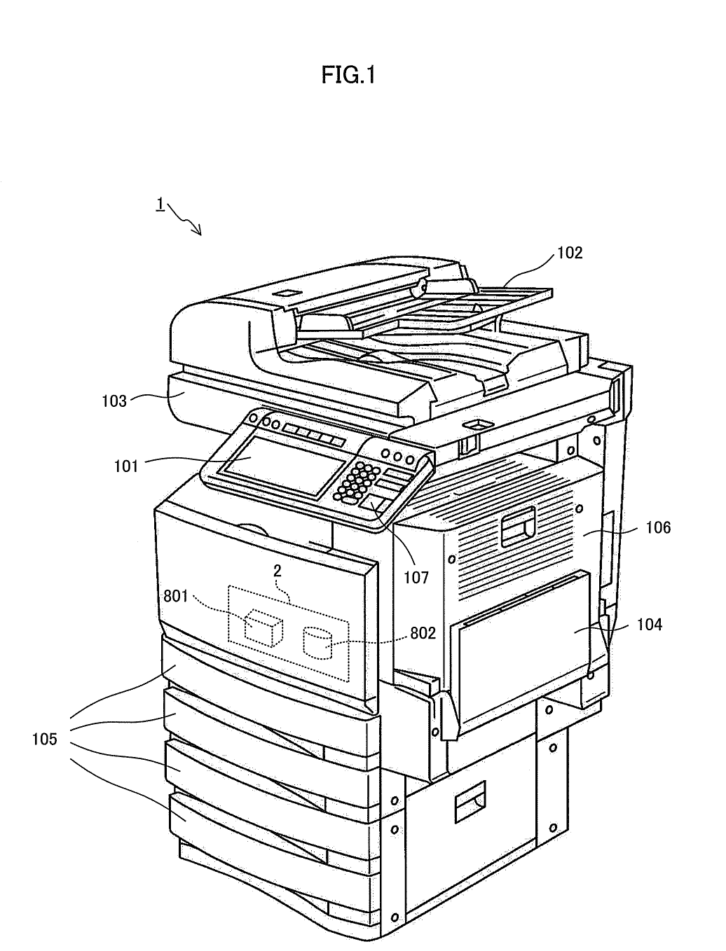

An embodiment of the present invention will be described below with reference to the accompanying drawings. FIG. 1 is a perspective view for explaining the outline of an image processing apparatus 1 including a display controller 2 and an interface screen 101 according to an embodiment of the present invention. The image processing apparatus 1 is an MFP (Multi Function Peripheral) in this example.

The image processing apparatus 1 according to the present embodiment includes an interface screen 101, an ADF (Auto Document Feeder) 102, an image reader section 103, a manual paper feeder 104, a paper feed cassette 105, an image forming section 106, an authentication processing section 107, and a display controller 2.

Operation of the image processing apparatus 1 according to the present embodiment will be described below briefly. When copy processing (predetermined image processing) is carried out using the image processing apparatus 1, user authentication processing is first performed in the authentication processing section 107. Subsequently, based on an input operation of a user, who has been authenticated through the authentication processing, to the interface screen 101, a document set in the ADF 102 is automatically fed toward a document read position in the image reader section (image processing section) 103. The document fed in this manner is read by the image reader section 103. Subsequently, a paper is fed from the paper feed cassette 105 or manual paper feeder 104 according to a paper feed setting selected based on the use's input operation to the interface screen 101. The fed paper then reaches the image forming section (image processing section) and is there subjected to image forming processing based on the image read by the image reader section 103, and the copy processing is completed.

The interface screen 101 is constituted by, e.g., a touch panel display and serves also as an input operation for receiving a user's input operation made based on the content displayed on the interface screen 101.

Next, the display controller 2 will be described in detail. The display controller 2 has a role of displaying on the interface screen 101 a plurality of objects to be displayed, such as characters or icons. The term “character” used here includes “symbol”, and “icon” includes “figure”.

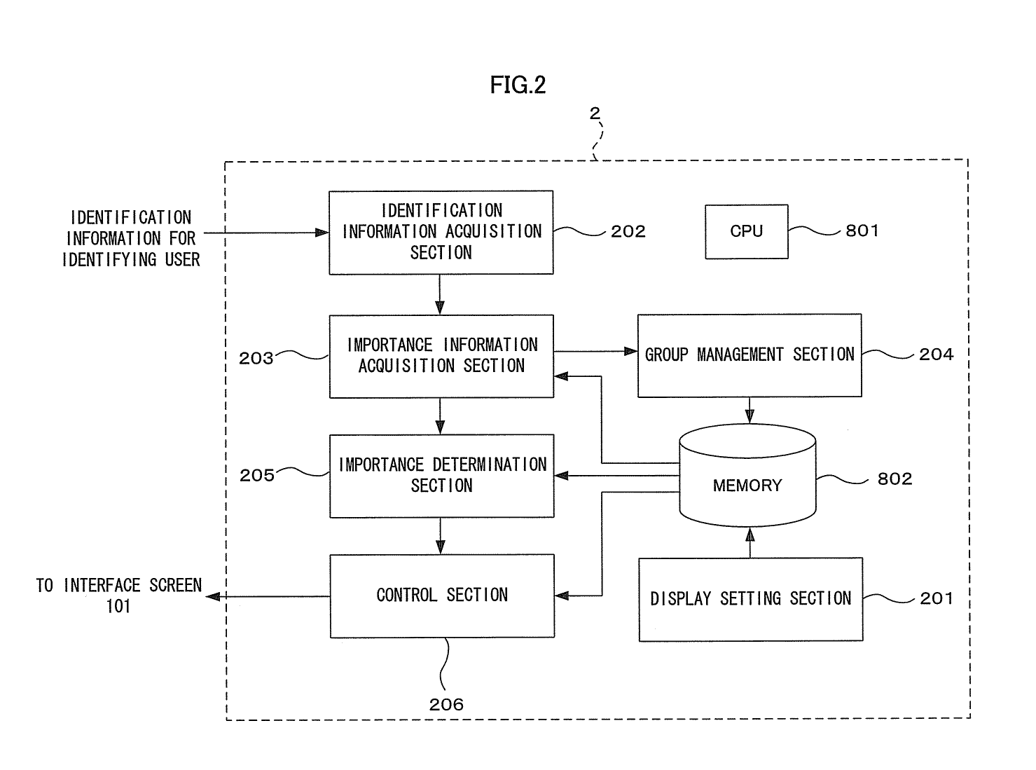

FIG. 2 is a block diagram for explaining the display controller 2 according to the present embodiment. The display controller 2 according to the present embodiment includes a display setting section 201, an identification information acquisition section 202, an importance information acquisition section 203, a group management section 204, an importance determination section 205, a control section 206, a CPU 801, and a MEMORY 802.

The identification information acquisition section 202 acquires user identification information, such as user ID acquired in authentication processing made by the authentication processing section 107. The authentication processing in the authentication processing section 107 is achieved by, e.g., an antenna provided in the authentication processing section 107 reading out user ID stored in a non-contact type IC card that a user has. It goes without saying that the acquisition of the identification information made in the authentication processing section 107 is not limited to this. For example, the identification information may be acquired from a key input or input of biological information such as fingerprint and voiceprint used in biometrics.

The importance information acquisition section 203 acquires information concerning the importance levels in the screen display which are associated with respective objects (icons, etc.) to be displayed on the interface screen 101. More specifically, the importance information acquisition section 203 acquires from the MEMORY 802 information concerning the selection history (operation log) of the user corresponding to the identification information acquired by the identification information acquisition section 202 at the time of display of the objects to be displayed on the screen.

In some cases, a plurality of icons to be displayed on the interface screen 101 may be categorized into some groups in the present embodiment. In this case, the importance information acquisition section 203 acquires from the MEMORY 802 information (group name, group identification number, and the like) concerning groups that the objects to be displayed respectively belong to.

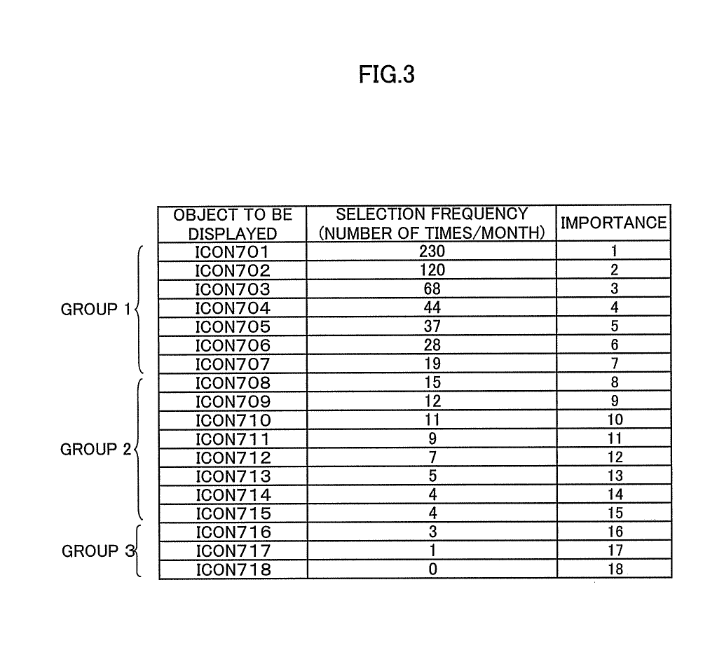

The importance determination section 205 determines, based on the information acquired by the importance information acquisition section 203, that the higher the selection frequency of a given object to be displayed, the higher the “importance in the screen display” thereof with respect to the user is. FIG. 3 is a table showing information indicating the selection frequencies of the respective objects to be displayed acquired by the importance information acquisition section 203 and importance levels determined by the importance determination section 205 based on the information indicating the selection frequencies. Although the selection frequencies of the objects to be displayed are measured on a per month basis in FIG. 3, selection frequencies on a per year basis or the aggregated number of selections in the image processing apparatus 1 may be used. Further, the frequencies at which the objects to be displayed are selected in the login time of a given user are recorded based on user ID of the user regardless of whether the objects to be displayed are selected on the screen of the image processing apparatus or PC, and the recorded information may be used as an index of the selection frequency.

At the login time of a given user corresponding to the identification information acquired by the identification information acquisition section 202, the control section 206 displays objects to be displayed based on the importance levels that the importance determination section 205 has determined using the selection history of the user corresponding to the identification information. More specifically, the control section 206 displays the objects to be displayed in the display area constituted by the first to n-th (n is an integer number more than 1) substantially ring-like areas, in which an (x−1)th (x is an integer from 2 to n) area is located inside an x-th area, such that objects to be displayed having higher importance than those to be displayed in the x-th area are displayed in the (x−1)th area.

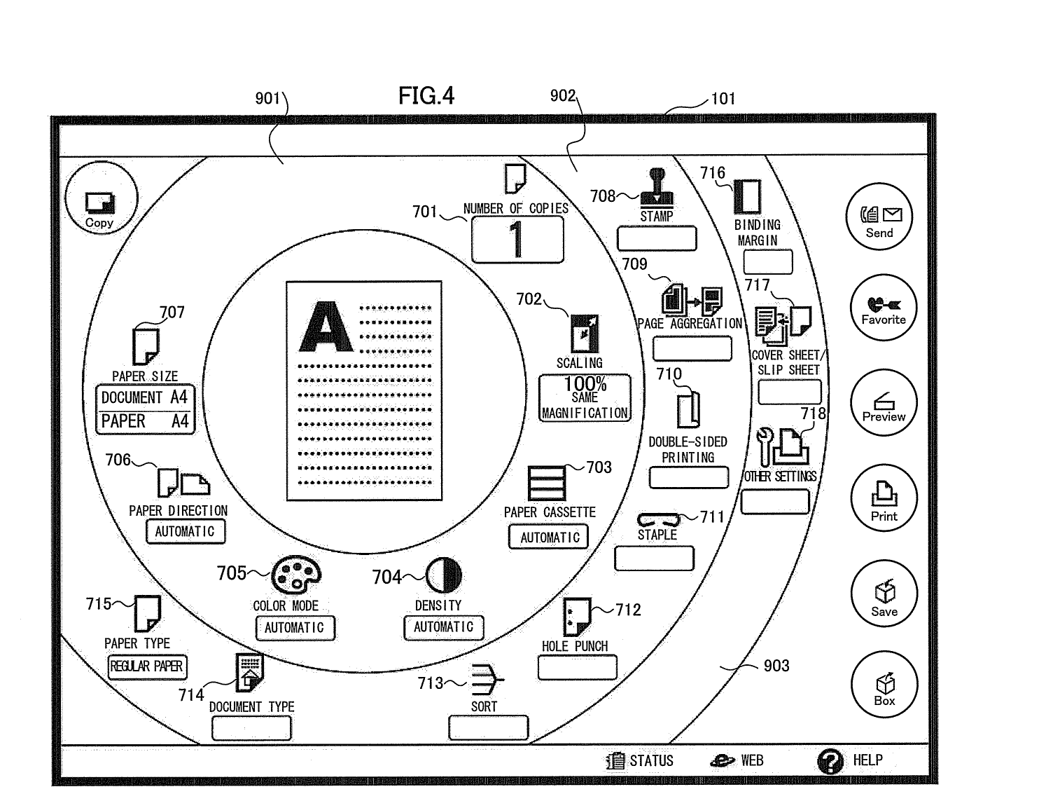

FIG. 4 is a screen display example which is displayed on the interface screen 101 under control of the control section 206. On the interface screen 101 shown in FIG. 4, a display area (corresponding to ring-like area) includes first to third circular ring-like areas 901 to 903 which are concentrically arranged. In this display area, the first circular ring-like area 901 is located inside the second circular ring-like area 902, and the second circular ring-like area 902 is located inside the third circular ring-like area 903.

The control section 206 arranges icons 701 to 718 on the first to third circular ring-like areas 901 to 903 based on the determination result of the importance determination section 205, which is as shown in FIG. 3. In this example, the first to third circular ring-like areas 901 to 903 are associated respectively with groups 1 to 3, wherein icons 701 to 707 belong to the group 1, icons 708 to 715 belong to the group 2, and icons 716 to 718 belong to the group 3. The number of icons that can belong to a given group is determined based on the number of icons that can be arranged in the circular ring-like area that the group is associated with.

Based on the information acquired by the importance information acquisition section 203, the control section 206 displays the objects to be displayed belonging to the groups associated with respective circular ring-like areas such that the icons belonging to a group having higher importance level are displayed in the more inner circular ring-like area. As described above, in the case where the objects to be displayed belong to groups associated with the respective circular ring-like areas, the group itself to which a given object to be displayed belongs indicates the importance of the objects to be displayed.

Besides, the number of icons that can be arranged in each of the circular ring-like area may be set regardless of the group to which the objects to be displayed belong. In this case, icons that cannot be accommodated in a given target circular ring-like area may be arranged in a circular ring-like area immediately outside the target circular ring-like area.

In the case where the information acquired by the importance information acquisition section 203 directly indicates the importance level, the control section 206 can perform the above display processing of the objects to be displayed without the determination of the importance determination section 205.

As described above, by displaying the objects to be displayed associated with a higher importance level in the more inner circular ring-like area, it is possible to concentrate objects to be displayed which need to be focused on or important objects to be displayed on a specified area on the screen. In particular, by determining the importance level based on the frequency at which a user selects the object to be displayed, it is possible to dispose the objects to be displayed that he or she often selects at a noticeable position, thus contributing to an improvement of user's convenience.

The control section 206 arranges, as shown in FIG. 4, a plurality of objects to be displayed in a given substantially ring-like area such that an object to be displayed having the highest importance is located at a predetermined uppermost position which is positioned above the center of the substantially ring-like area and, starting from the uppermost position, residual objects to be displayed are arranged clockwise in the order of their importance. As described above, the human nature that we move our eyes clockwise when observing objects arranged in a ring is utilized to attract user's attention. In the example of FIG. 3, the selection frequencies per month of the icons 714 and 715 belonging to the group 2 associated with the circular ring-like area 902 are the same. To cope with such a case, the priority between the icons is previously defined to thereby determine the arrangement order of the icons.

As described above, the interface screen according to the present embodiment is constituted by the ring-like area including a plurality of circular ring-like areas and plurality of icons (input sections) 701 to 718 for receiving a user's input operation.

Based on the information acquired by the importance information acquisition section 203, the group management section 204 relocates an object to be displayed whose selection frequency has exceeded a predetermined threshold value to a group associated with a substantially ring-like area more inner than an area with which a group to which the object to be displayed has originally belonged is associated. This allows the object to be displayed having a high selection frequency to be positioned nearer to the center of the display area. As a result, it is possible to dispose the objects to be displayed that a user often selects at a noticeable position, allowing the interface screen to be changed to a more user-friendly screen.

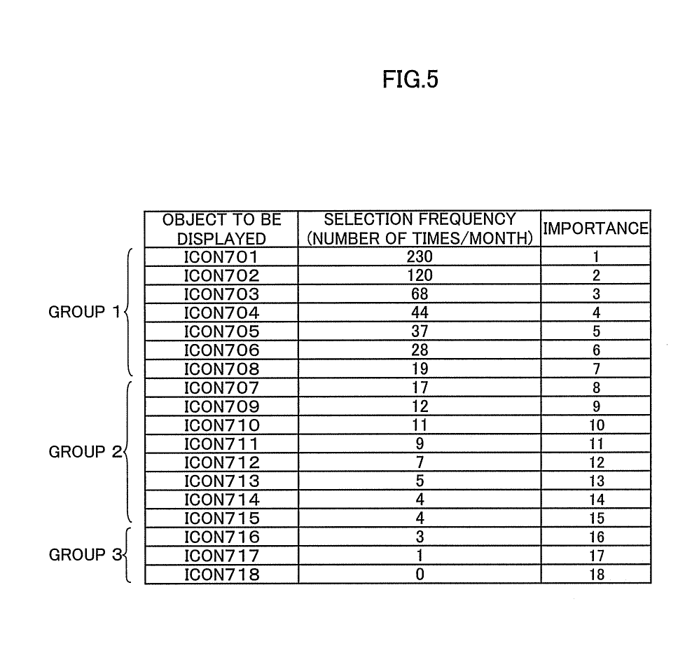

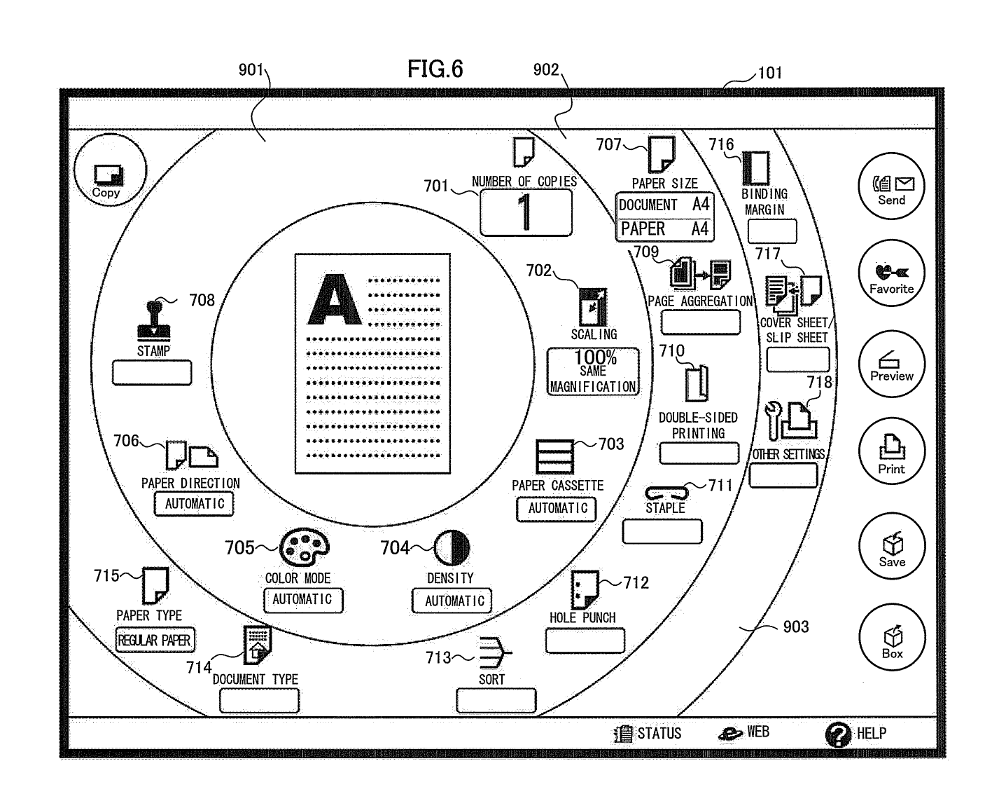

FIG. 5 is a table for explaining an example in which groups of object to be displayed are changed in accordance with the selection frequency. As shown in FIG. 5, the icon 708 whose selection frequency is increased from 15 times/month (FIG. 3) to 19 times/month is relocated to group 1. In this example, the predetermined threshold value is “18 times/month”. On the other hand, the icon 707 whose selection frequency is decreased from 19 times/month (FIG. 3) to 17 times/month is relocated to group 2. FIG. 6 is a view showing an example in which the interface screen is displayed based on the grouping changed as explained using FIG. 5.

Out of a plurality of objects to be displayed such as icons or characters to be displayed on the interface screen 101, given objects to be displayed may be located by the display setting section 201 at a position in the circular ring-like area which is defined in response to a user's input. The control section 206 displays the objects to be displayed whose display positions have been set by the display setting section 201 at the set positions in the substantially ring-like area.

This configuration allows given objects to be always displayed at given position in the ring-like area, which allows an icon or the like that needs to be always displayed at a specified position to be displayed at the specified position independently of the use frequency or grouping. As a result, it is possible to ensure convenience for a user who memorizes various functions by the locations of the corresponding icons or a visually-handicapped user who performs input operation by memorizing the locations of the icons.

Further, the control section 206 locates the circular ring-like display area on the left side or upper side relative to the center position of the entire screen. In general, a user interface is designed under the principle that an element having high importance should be located on the left side or upper side while an element having low importance should be located on the right side or lower side. Therefore, it is preferable to arrange the icons on the screen on the above principle. That is, when the entire display area is located on the left side, upper side, or upper-left side relative to the center position of the screen, icons having high importance are inevitably located on the left side, upper side, or upper-left side relative to the center position of the screen while icons having low importance arranged in an outer ring-like area are inevitably located on the right side, lower side, or lower-right side relative to the center of the screen. Thus, it is possible to arrange the icons on the general design principle of the user interface (in a user-friendly manner), contributing to enhancement of operability.

The above ring-like area need not be formed in a completely ring-like shape but may be a shape having a cutaway portion (substantially ring-like shape) (see FIG. 4 and FIG. 6). That is, it is only necessary for the ring-like area to surround an adjacently inner area to such a degree that a user can recognize which of two adjacent circular ring-like areas is located inside.

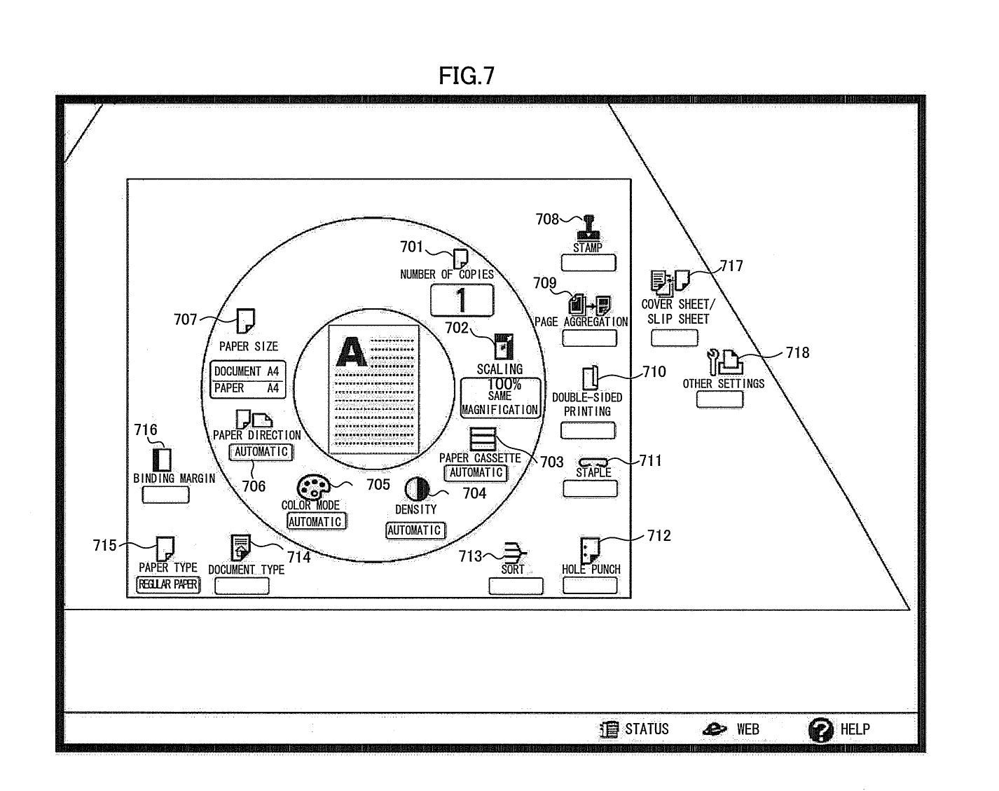

Further, a use of the ring-like area allows a user to easily grasp the importance of the icon based on the radius (distance) from the center of the concentric circle, so that the ring-like area is preferably a circular ring-like shape. However, the shape of the ring-like area is not limited to this, but may be a ring-like area having a polygonal outline as shown in FIG. 7. Further, a plurality of ring-like areas adjacently arranged to one another need not have similar outline, but a plurality of ring-like areas having different outlines may be combined.

In the case where the ring-like area has a polygonal outline, it is possible to give visual meaning to corner portions. Utilizing this, the control section 206 arranges objects to be displayed by associating their belonging groups and side portions located between the corners of the substantially ring-like area (that is, in the example of FIG. 7, icons 709 to 711 and icons 713 to 714 belong to different groups).

Similarly, in the case of the ring-like area having a polygonal outline, the control section 206 arranges a previously set predetermined object to be displayed at the corner of the substantially ring-like area. By arranging a specified icon at a noticeable position such as the corner portion as described above, it is possible to increase attention to the specified icon.

The CPU 801 has a role of executing various processing in the image processing apparatus 1 and display controller 2 and, at the same time, has a role of executing a program stored in the MEMORY 802 so as to realize various functions. The MEMORY 802, which is constituted by an ROM or RAM, has a role of storing various information or programs used in the image processing apparatus 1 and display controller 2.

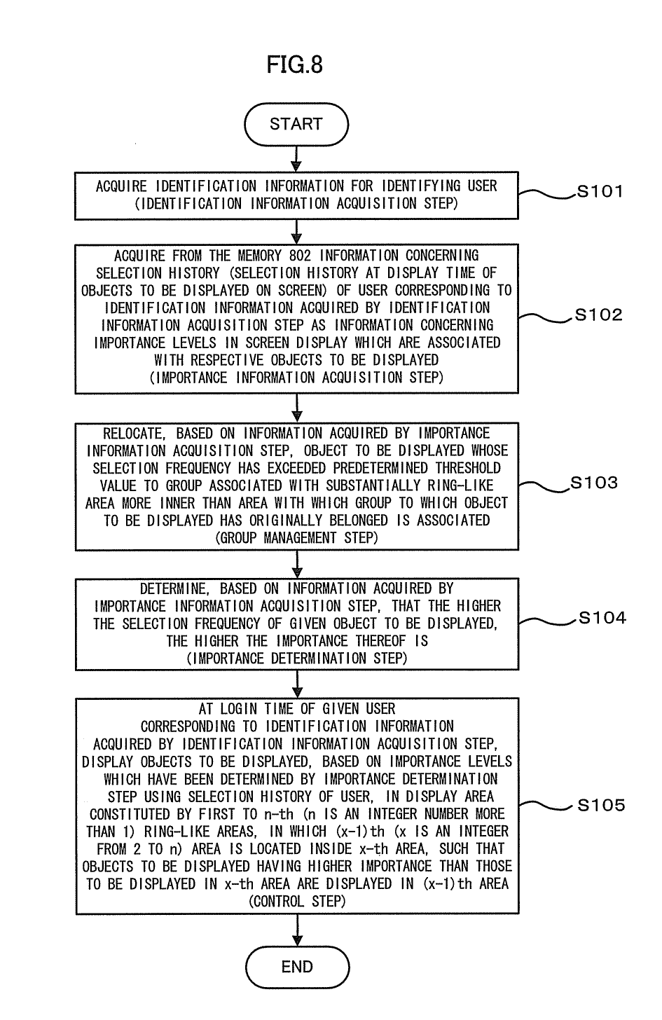

FIG. 8 is a flowchart for explaining a procedure of processing (display control method) performed in the display controller according to the present embodiment.

The identification information acquisition section 202 acquires identification information for identifying a user (identification information acquisition step) (S101).

The importance information acquisition section 203 acquires from the MEMORY 802 information concerning the selection history (selection history at the display time of the objects to be displayed on the screen) of the user corresponding to the identification information acquired by the identification information acquisition step as information concerning the importance levels in the screen display which are associated with respective objects to be displayed (importance information acquisition step) (S102). In the case where a plurality of objects to be displayed on the interface screen 101 are categorized into some groups, the importance information acquisition section 203 acquires from the MEMORY 802 information concerning groups that the objects to be displayed respectively belong to.

Based on the information acquired by the importance information acquisition step, the group management section 204 relocates an object to be displayed whose selection frequency has exceeded a predetermined threshold value to a group associated with a substantially ring-like area more inner than an area with which a group to which the object to be displayed has originally belonged is associated (group management step) (S103).

The importance determination section 205 determines, based on the information acquired by the importance information acquisition step, that the higher the selection frequency of a given object to be displayed, the higher the importance thereof is (importance determination step) (S104).

At the login time of a given user corresponding to the identification information acquired by the identification information acquisition step, the control section 206 displays objects to be displayed, based on the importance levels that the importance determination step has determined using the selection history of the user corresponding to the identification information, in the display area constituted by the first to n-th (n is an integer number more than 1) substantially ring-like areas, in which an (x−1)th (x is an integer from 2 to n) area is located inside an x-th area, such that objects to be displayed having higher importance than those to be displayed in the x-th area are displayed in the (x−1)th area (control step) (S105). The term “login time” used here means a state where a login process required to display the objects to be displayed on the interface screen 101 is achieved. Therefore, a login target is not limited to the image processing apparatus 1 but may be a network for enabling a use of the image processing apparatus 1. Further, in the control step, a plurality of objects to be displayed in a given substantially ring-like area arranged such that an object to be displayed having the highest importance is located at a predetermined uppermost position which is positioned above the center of the ring-like area and, starting from the uppermost position, residual objects to be displayed are arranged clockwise in the order of their importance.

In the case where the information acquired by the importance information acquisition step directly indicates the importance level, the control section 206 can display, based on the acquired information, the objects to be displayed in the display area constituted by the first to n-th (n is an integer number more than 1) substantially ring-like areas, in which an (x−1)th (x is an integer from 2 to n) area is located inside an x-th area, such that objects to be displayed having higher importance than those to be displayed in the x-th area are displayed in the (x−1)th area.

Further, based on the information acquired by the importance information acquisition step, the control section 206 displays the objects to be displayed belonging to the groups associated with respective circular ring-like areas such that the icons belonging to a group having higher importance level are displayed in the more inner circular ring-like area.

Although the group management step (S103) is executed ahead of the importance determination step (S104) in the flowchart shown in FIG. 8, the execution timing of the group management step (S103) is not limited to this. For example, the group management step may be executed after the control step (S105) and, in this case, a processing result of the group management step can be reflected on the screen at the time of execution of the subsequent control step.

The above respective steps in the processing performed in the display controller 2 are realized by the CPU 801 executing a display control program stored in the MEMORY 802.

In the embodiment, there has been explained the case where the function for implementing the present invention is previously stored inside the apparatus, but the present invention is not limited thereto, and a similar function may be downloaded from the network into the apparatus or a recording medium on which a similar function is stored is installed in the apparatus. The recording medium may be any form of recording medium such as CD-ROM which can store programs and is readable by the apparatus. The function which can be previously obtained through installing or downloading may be realized in cooperation with the OS (operating system) inside the apparatus.

Although a storage area that stores information set by the group management section 204 and display setting section 201 and a storage area from which the importance information acquisition section 203, importance determination section 205, and control section 206 read information is realized by the MEMORY 802 (i.e., MEMORY 802 stores necessary information) in the present embodiment for the sake of simplicity, the storage area may be realized by, e.g., a database provided outside the image processing apparatus 1. That is, the storage area may be provided at any location as long as it can exchange information with the group management section 204, display setting section 201, importance information acquisition section 203, importance determination section 205, and control section 206.

Further, the selection history of the objects to be displayed stored in association with the user ID of each user is used for determination of the arrangement order of the objects to be displayed in the present embodiment. Alternatively, however, in the case where the icon selection frequency of each department to which an individual user belongs shows a more distinct feature than that of the individual user, ID of the department to which the user belongs to is acquired based on the user ID obtained through user authentication processing, and the icon selection history information of all users belonging to the department which are stored in association with the ID of the department is used for determination of the arrangement order of the objects to be displayed.

Further, although the image processing apparatus 1 is an MFP in the present embodiment, it goes without saying that the present invention is applicable to a printer, scanner, PC (Personal Computer), and MMK (Multi Media Kiosk), i.e., an apparatus that performs predetermined image processing such as image forming processing, image read processing, image edit processing, and image pickup processing.

Although the exemplary embodiment of the present invention has been shown and described, it will be apparent to those having ordinary skill in the art that a number of changes, modifications, or alternations to the invention as described herein may be made within the spirit of the present invention.

As has been described in detail, according to the present invention, it is possible to provide a technique capable of appropriately arranging a plurality of objects to be displayed such as icons on a screen so as to contribute to an improvement of convenience for each user.

What is claimed is:

1. A display controller for controlling display of a plurality of objects to be displayed, comprising:
an importance information acquisition section that acquires information concerning the importance levels in the screen display which are associated with respective objects to be displayed; and
a control section that displays objects to be displayed, based on the information acquired by the importance information acquisition section, in the display area constituted by the first to n-th (n is an integer number more than 1) substantially ring-like areas, in which an (x−1)th (x is an integer from 2 to n) area is located inside an x-th area, such that objects to be displayed having higher importance than those to be displayed in the x-th area are displayed in the (x−1)th area.

2. The display controller according to claim 1, wherein
the control section arranges a plurality of objects to be displayed in the substantially ring-like area such that an object to be displayed having the highest importance is located at a predetermined uppermost position which is positioned above the center of the substantially ring-like area and, starting from the uppermost position, residual objects to be displayed are arranged clockwise in the order of their importance.

3. The display controller according to claim 1, wherein
the importance information acquisition section acquires information concerning the selection history of the objects to be displayed at the time of display of the objects to be displayed on the screen,
the display controller comprises an importance determination section that determines, based on the information acquired by the importance information acquisition section, that the higher the selection frequency of a given object to be displayed, the higher the importance thereof is, and
the control section displays objects to be displayed, based on the importance determined by the importance determination section, in the display area constituted by the first to n-th (n is an integer number more than 1) substantially ring-like areas, in which an (x−1)th (x is an integer from 2 to n) area is located inside an x-th area, such that objects to be displayed having higher importance than those to be displayed in the x-th area are displayed in the (x−1)th area.

4. The display controller according to claim 3, comprising:
an identification information acquisition section that acquires identification information of a user, wherein
the importance information acquisition section acquires information concerning the selection history of the user corresponding to the identification information acquired by the identification information acquisition section, and
at the login time of a given user corresponding to the identification information acquired by the identification information acquisition section, the control section displays objects to be displayed, based on the importance levels that the importance determination section has determined using the selection history of the user corresponding to the identification information, in the display area constituted by the first to n-th (n is an integer number more than 1) substantially ring-like areas, in which an (x−1)th (x is an integer from 2 to n) area is located inside an x-th area, such that objects to be displayed having higher importance than those to be displayed in the x-th area are displayed in the (x−1)th area.

5. The display controller according to claim 1, wherein
the object to be displayed belongs to any one of groups associated with the respective substantially ring-like areas,
the importance information acquisition section acquires information concerning the group to which the object to be displayed belongs, and
based on the information acquired by the importance information acquisition section, the control section displays the objects to be displayed belonging to the groups associated with respective substantially ring-like areas such that the objects to be displayed belonging to a group having higher importance level are displayed in the more inner ring-like area.

6. The display controller according to claim 5, wherein
the importance information acquisition section acquires information concerning the selection history of the objects to be displayed at the time of display thereof on the screen, and
the display controller comprises a group management section that relocates, based on the information acquired by the importance information acquisition section, an object to be displayed whose selection frequency has exceeded a predetermined threshold value to a group associated with a substantially ring-like area more inner than an area with which a group to which the object to be displayed has originally belonged is associated.

7. The display controller according to claim 1, wherein
the substantially ring-like area is a substantially circular ring-like area.

8. The display controller according to claim 5, wherein
the substantially ring-like area is a ring-like area having a polygonal outline, and
the control section arranges objects to be displayed by associating their belonging groups and side portions located between the corners of the substantially ring-like area.

9. The display controller according to claim 1, wherein
the substantially ring-like area is a ring-like area having a polygonal outline, and
the control section arranges a previously set predetermined object to be displayed at the corner of the substantially ring-like area.

10. The display controller according to claim 1, comprising:
a display setting section that sets a display position in the substantially ring-like area of a given object to be displayed, wherein
the control section displays the objects to be displayed whose display positions have been set by the display setting section at the set positions in the substantially ring-like area.

11. The display controller according to claim 1, wherein
the control section locates the display area on the left side or upper side relative to the center position of the entire screen.

12. The display controller according to claim 1, wherein
the objects to be displayed include characters or icons.

13. An image processing apparatus comprising:
the display controller according to claim 1;
an operation input section that receives a user's input operation made based on the content displayed by the display controller; and
an image processing section that performs predetermined image processing based on the input received by the input operation section.

14. A display control method for controlling display of a plurality of objects to be displayed, comprising:
an importance information acquisition step that acquires information concerning the importance levels in the screen display which are associated with respective objects to be displayed; and
a control step that displays objects to be displayed, based on the information acquired by the importance information acquisition step, in the display area constituted by the first to n-th (n is an integer number more than 1) substantially ring-like areas, in which an (x−1)th (x is an integer from 2 to n) area is located inside an x-th area, such that objects to be displayed having higher importance than those to be displayed in the x-th area are displayed in the (x−1)th area.

15. The display control method according to claim 14, wherein
the control step arranges a plurality of objects to be displayed in the substantially ring-like area such that an object to be displayed having the highest importance is located at a predetermined uppermost position which is positioned above the center of the substantially ring-like area and, starting from the uppermost position, residual objects to be displayed are arranged clockwise in the order of their importance.

16. The display control method according to claim 14, wherein
the importance information acquisition step acquires information concerning the selection history of the objects to be displayed at the time of display of the objects to be displayed on the screen,
the display control method comprises an importance determination step that determines, based on the information acquired by the importance information acquisition step, that the higher the selection frequency of a given object to be displayed, the higher the importance thereof is, and
the control step displays objects to be displayed, based on the importance determined by the importance determination step, in the display area constituted by the first to n-th (n is an integer number more than 1) substantially ring-like areas, in which an (x−1)th (x is an integer from 2 to n) area is located inside an x-th area, such that objects to be displayed having higher importance than those to be displayed in the x-th area are displayed in the (x−1)th area.

17. The display control method according to claim 16, comprising:
an identification information acquisition step that acquires identification information of a user, wherein
the importance information acquisition step acquires information concerning the selection history of the user corresponding to the identification information acquired by the identification information acquisition step, and
at the login time of a given user corresponding to the identification information acquired by the identification information acquisition step, the control step displays objects to be displayed, based on the importance levels that the importance determination step has determined using the selection history of the user corresponding to the identification information, in the display area constituted by the first to n-th (n is an integer number more than 1) substantially ring-like areas, in which an (x−1)th (x is an integer from 2 to n) area is located inside an x-th area, such that objects to be displayed having higher importance than those to be displayed in the x-th area are displayed in the (x−1)th area.

18. The display control method according to claim 14, wherein
the object to be displayed belongs to any one of groups associated with the respective substantially ring-like areas,
the importance information acquisition step acquires information concerning the group to which the object to be displayed belongs, and
based on the information acquired by the importance information acquisition step, the control step displays the objects to be displayed belonging to the groups associated with respective substantially ring-like areas such that the objects to be displayed belonging to a group having higher importance level are displayed in the more inner ring-like area.

19. The display control method according to claim 18, wherein
the importance information acquisition step acquires information concerning the selection history of the objects to be displayed at the time of display thereof on the screen, and
the display control method comprises a group management step that relocates, based on the information acquired by the importance information acquisition step, an object to be displayed whose selection frequency has exceeded a predetermined threshold value to a group associated with a substantially ring-like area more inner than an area with which a group to which the object to be displayed has originally belonged is associated.
